(19) United States
(12) Patent Application Publication
(10) Pub. No.: US 2012/0110892 A1
(43) Pub. Date: May 10, 2012

(54) Mosquito Trap

(75) Inventors: Jeffrey D. LLOYD, Knoxville, TN (US); Janet KINTZ-EARLY, Knoxville, TN (US)

(73) Assignee: NISUS CORPORATION, Rockford, TN (US)

(21) Appl. No.: 13/279,741

(22) Filed: Oct. 24, 2011

Related U.S. Application Data
(60) Provisional application No. 61/410,382, filed on Nov. 5, 2010.

(51) Int. Cl. A01M 1/10; A01M 1/20

(52) U.S. Cl. 43/107

(57) ABSTRACT

The present disclosure provides a mosquito trap which includes a mosquito trap enclosure having at least one sidewall and an interior space within the enclosure. A combination of water and biomass which is attractive to mosquitoes is located within the enclosure interior space. The trap also includes at least one entry point formed in the enclosure sidewall allowing mosquitoes to enter the enclosure. In addition, the trap includes a conduit having a first opening which is connected to the enclosure entry point and a second opening which is located within the enclosure interior space. The enclosure interior space is capable of retaining the combination of water and biomass without spillage if the enclosure is overturned.

### FIELD

The present disclosure relates in general to systems for insect control and, in particular, to system for trapping and killing mosquitoes.

### BACKGROUND

In addition to being a pest, mosquitoes are capable of carrying and infecting both persons and livestock with numerous deadly diseases including malaria, dengue fever, West Nile virus, yellow fever, and encephalitis. On a global basis, these diseases are responsible for millions of deaths each year. Consequently, there is a great need for effective methods to control mosquitoes, and thereby limit outbreaks of mosquito-borne diseases.

While a variety of chemical insecticides are known which are capable of killing mosquitoes (for instance DDT) ingestion of such insecticides is also harmful to persons, especially children, and livestock. Thus, there is also a need for effective methods to control mosquito populations while simultaneously limiting the exposure of persons and livestock to harmful insecticides.

### SUMMARY

In a first aspect, the present disclosure provides a mosquito trap. In one embodiment, the trap includes a mosquito trap enclosure having at least one sidewall and an interior space within the enclosure. A combination of water and biomass which is attractive to mosquitoes is located within the enclosure interior space. The trap also includes at least one entry point formed in the enclosure sidewall allowing mosquitoes to enter the enclosure. In addition, the trap includes a conduit having a first opening which is connected to the enclosure entry point and a second opening which is located within the enclosure interior space. The enclosure interior space is capable of retaining the combination of water and biomass without spillage if the enclosure is overturned.

In certain embodiments of the mosquito trap, rainwater is substantially prevented from entering the enclosure interior space by the conduit.

In certain embodiments of the mosquito trap, it is preferred that at least a first portion of the at least one sidewall is translucent. It is also preferred that the conduit is substantially opaque. More preferably, the at least one sidewall also includes a second portion which is opaque.

In certain embodiments of the mosquito trap, the conduit is preferably configured in a shape which substantially prevents exterior light which enters the first opening of the conduit from passing through the conduit and out the second opening of the conduit In certain embodiments of the mosquito trap, the combination of water and biomass preferably further includes an insecticide. Suitable insecticides may be selected from the group consisting of insect growth regulators, microbial larvaecides, organophosphates, synthetic pyrethroids, neonicotinoids, fipronil, surface oils or films and mixtures thereof.

In certain embodiments of the mosquito trap, the combination of water and biomass preferably has a volume which is from about 10 to about 50 percent of the total volume of the enclosure interior space. More preferably, the combination of water and biomass has a volume which is from about 20 to about 40 percent of the total volume of the enclosure interior space

In certain embodiments of the mosquito trap, the combination of water and biomass located within the enclosure interior space preferably has volume which is from about 0.5 to about 50 liters. More preferably, the enclosure interior space has a volume which is from about 0.25 to about 25 liters.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a side elevation view of a mosquito trap in accordance with one embodiment of the present disclosure and

FIG. 2 is a side elevation view of a mosquito trap in accordance with an alternative embodiment of the present disclosure.

### DETAILED DESCRIPTION

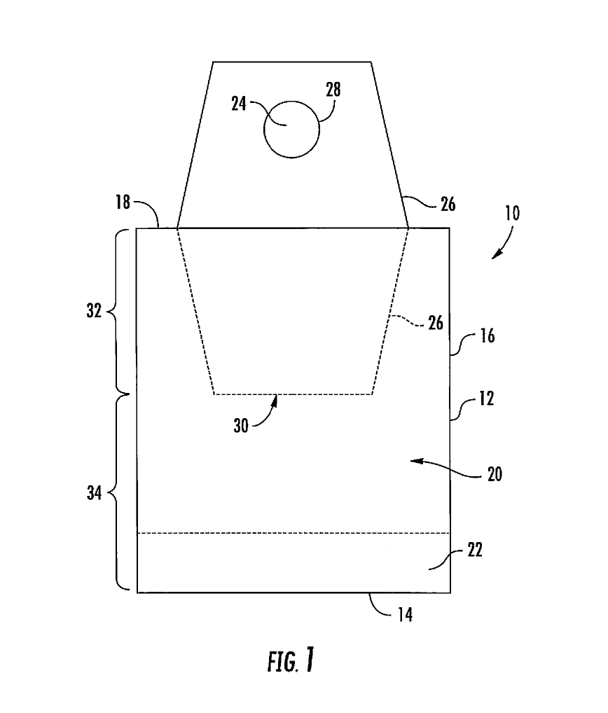

In a first aspect, the present disclosure provides a mosquito trap 10. In one embodiment, the trap 10 preferably includes a mosquito trap enclosure 12 having a bottom 14, at least one sidewall 16, a top 18, and an interior space 20 as shown in FIG. 1. A combination of water and biomass 22 which is attractive to mosquitoes is located within the enclosure interior space 20. The trap 10 also includes at least one entry point 24 formed in the enclosure 12 for allowing mosquitoes to enter the enclosure 12. In addition, the trap 10 includes a conduit 26, formed from a material which is substantially opaque, having a first opening 28 which is connected to the enclosure entry point 24 and a second opening 30 which is located within the enclosure interior space 20. At least a first portion 32 of the at least one sidewall 16 is translucent.

In certain embodiments, the mosquito trap enclosure 12 may be generally cylindrical in shape, having only a single, round sidewall 16. In still other embodiments, the mosquito trap enclosure 12 may be shaped as a sphere or as a prism, having three or four or more sidewalls. The enclosure 12 generally has a volume of from about 0.5 to about 50 liters, more preferably from about 2 to about 4 liters. Suitable materials for use in constructing the mosquito trap enclosure 12 include metals, plastics (such as polyethylene, polypropylene, polycarbonate, polyvinyl chloride, polystyrene, and/or biodegradable plastics such as polylactic acid), glass, and combinations thereof.

In certain embodiments, at least a portion of the sidewalls 16 is translucent. In instances, the sidewalls may include more than one translucent portion 32. These translucent portions 32 are preferably located near the top of the sidewalls 16. The remaining portion 34 of the sidewalls 16 is preferably substantially opaque. As used herein, the term “translucent” refers to materials which generally allow light to pass through the materials. “Translucent” includes materials which are sometimes referred to as “transparent.” The term “opaque” is used herein to refer to materials which generally do not allow light to pass through.

As described in greater detail below, it is believed that the translucent portions 32 of the sidewalls 16 act as false exits. Mosquitoes which have flown into the enclosure 12 perceive the external light which passes the translucent portions 32 and fly towards the translucent portions 32 believing them to be opening which provide a means of escape from the trap 10. Instead, the translucent portions 32 trap the mosquitoes within the enclosure 12 and provide no means of escape.

The enclosure 12 also includes at least one entry point 24, generally formed in either the top 18 or in one of the sidewalls 16, which provides a means for mosquitoes to enter the trap 10. This entry point 24 is typically from about 5 mm to about 50 mm in size. As described below, however, this entry point 24 is generally hidden from the mosquitoes once they have entered the trap 10. Thus, the mosquitoes cannot use this entry point 24 as a means of escape.

The entry point 24 is connected to a conduit 26 located within the mosquito trap enclosure. The conduit 26 is a hollow, tube-like structure having a first opening 28 and a second opening 30. In some embodiments, the walls of the conduit 26 may expand in diameter along a portion of the length of the conduit 26 and then taper along another portion of the length of the conduit, as seen in FIG. 1. The first opening 28 of the conduit 26 is connected to the enclosure entry point 24. The second opening 30 is positioned is located within the interior space 20 of the enclosure, preferably need the bottom 14 of the enclosure. Thus, mosquitoes enter the trap 10 by flying through the enclosure entry point 24 and down the conduit 26 to reach the interior of the trap 10. In certain embodiments, the conduit 26 is preferably made from a material which is opaque and/or coated with a material which is opaque.

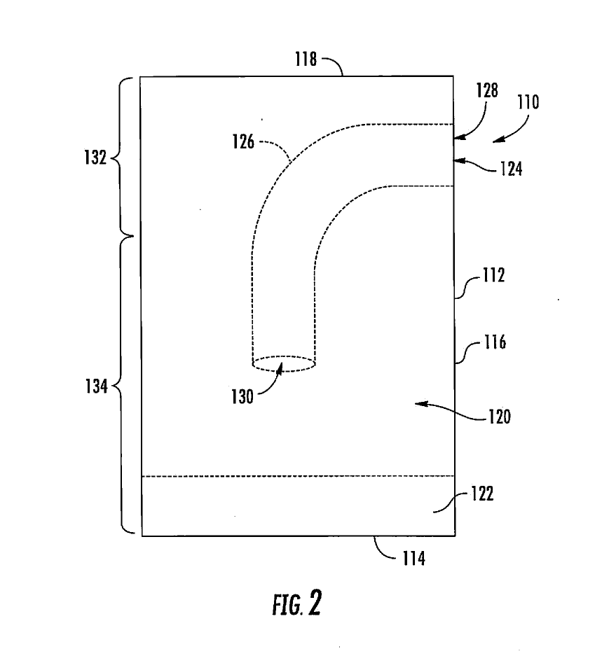

A second embodiment of the mosquito trap is illustrated in FIG. 2. As before, the trap 110 includes a mosquito trap enclosure 112 having a bottom 114, at least one sidewall 116, a top 118, and an interior space 120. A combination of water and biomass 122 which is attractive to mosquitoes is located within the enclosure interior space 120. The trap 110 also includes at least one entry point 124 formed in the enclosure 112 for allowing mosquitoes to enter the enclosure 112. In addition, the trap 110 includes a conduit 126, formed from a material which is substantially opaque, having a first opening 128 which is connected to the enclosure entry point 124 and a second opening 130 which is located within the enclosure interior space 120. At least a first portion 132 of the at least one sidewall 116 is translucent. The remaining portion 134 of the sidewall is preferably opaque.

In addition, in this embodiment, the conduit 126 is preferably configured in a shape which substantially prevents exterior light from passing through the conduit 126 out the second opening 130 of the conduit 126 after the light enters the first opening 128 of the conduit. For instance, the length of the conduit 126 may be curved or bent at an angle which prevents light from traveling in a straight line from the first opening 128 of the conduit 126 to the second opening 130, as illustrated in FIG. 2. In certain embodiments, the first and second openings 128, 130 may also be offset from one another. This again prevents light from traveling in a straight line from the first opening 128 of the conduit 126 to the second opening 130. Consequently, the conduit 126 effectively hides the enclosure entry point 24 from mosquitoes within the enclosure interior space 120 and thus prevents escape from the trap 110 via the enclosure entry point 124.

With further reference to FIG. 1, at least one attractant is placed within the interior of the mosquito trap 10 in order to draw mosquitoes into the trap 10. Preferably, a combination of water and biomass 22, such as algae and/or decaying plant matter, are placed in the bottom 14 of the enclosure 12 in order to attract mosquitoes. The combination of water and decaying biomass 22 provides a condition which is favored by female mosquitoes for laying their eggs. Thus, female mosquitoes which are ready to lay their eggs are drawn into the enclosure 12 and deposit their eggs therein.

In certain embodiments, the water and/or biomass 22 within the enclosure 12 may be treated with an insecticide in order to kill the mosquitoes, and/or their eggs and larvae. For instance, the water and/or biomass may be treated with an insecticide selected from the group consisting of insect growth regulators (such as methoprene), microbial larvaecides (such as Bacillus thuringiensis and/or Bacillus sphaericus), organophosphates (such as DDT, Temphos and dichlorvos), synthetic pyrethroids (such as bifenthrin, cypermethrin and deltamethrin), neonicotinoids (such as imidacloprid), fipronil, surface oils or films and mixtures thereof. In certain embodiments, live fish may also be included in the water and/or biomass 22 and the fish may consume mosquitoes which land on or near the water and/or biomass 22.

The amount of water and biomass 22 within the enclosure 12 is generally relatively small in comparison to the overall size of the enclosure 12. The combination of water and biomass 22 generally has a volume which is from about 10 to about 50 percent of the total volume of the enclosure interior space 20. More preferably, the combination of water and biomass 22 has a volume which is from about 20 to about 40 percent of the total volume of the enclosure interior space 20.

By keeping the volume of water and biomass 22 relatively small in comparison to the overall volume of the enclosure interior space 20, the present disclosure provides a mosquito trap 10 which is preferably substantially spill-proof if overturned. That is, if the enclosure 12 if turned on its side, either accidentally or purposely, the water and biomass 22 will still be retained within the interior of the trap enclosure 12 with little or no spillage. This provides several advantages. First, by retaining the fluids within the enclosure 12, the effectiveness of the trap 10 is maintained even after it has been overturned. Secondly, this prevents children or animals from ingesting or otherwise coming in contact with the water and biomass 22, which again may include harmful insecticides.

In addition, rainwater is substantially prevented from entering the enclosure 12 by way of the conduit 26. This is advantageous because the addition of rainwater could otherwise overfill the enclosure, rendering it ineffective. Even worse, an overfilled enclosure 12 could become a breeding ground for mosquitoes, rather than functioning as a mosquito trap.

In certain embodiments, the enclosure 12 may also include other mosquito attractants such as a light source and/or chemical attractants such 1-octen-3-ol (octenol) and/or a carbon dioxide source. In some instances, a live mammal, such as a small rodent, may be placed within the enclosure to act as a natural attractant source of carbon dioxide and octenol.

When used in the field, one or more mosquito traps 10 are prepared in accordance with the present disclosure and then set out in a mosquitoes-infested area in order to attract, trap, and kill mosquitoes.

In particular, the mosquito traps 10 will attract, trap, and kill female mosquitoes. Female mosquitoes are, of course, the only mosquitoes to lay eggs. In addition, only female mosquitoes bite humans and animals in order to consume blood. Male mosquitoes subsist solely from a plant diet. Thus, only female mosquitoes are capable of infecting persons and livestock with blood-borne diseases. Thus, it is particularly desirable to trap and kill female mosquitoes in order to control the outbreak of such diseases.

Even the female mosquito only feeds upon blood prior to laying eggs. Once this “blood meal” has been consumed, the female mosquito is then compelled to lay her eggs and will preferably seek out a dark, wet environment in which to do so. The water and biomass 22 within the interior of the mosquito trap 10 provide the mosquito with a seemingly ideal environment for egg laying. Thus, the water and biomass 22 attract female mosquitoes to the mosquito trap 10 through a combination of sight and smell in order to lay their eggs (oviposit).

In order to improve the effectiveness of the mosquito trap, it is desirable to reduce or eliminate other sources of standing water from the vicinity of the trap so that the mosquitoes do not have the option to oviposit in these alternative water sources rather in the trap. For example, nearby rain gutters should be cleared to prevent standing water, and automotive tires which might house rainwater should be removed treated. Likewise, water in fountains is preferably treated with chlorine, or a mosquito larvacide such as Bacillus thuringiensis or methoprene to prevent oviposit by mosquitoes. Nearby ponds may be similarly treated or else stocked with fish which consume mosquitoes and/or their larvae.

The attraction of the water and biomass 22 entices the female mosquitoes to enter though the enclosure entry point 24 and into the enclosure interior space 20 in order to reach the bottom 14 of the enclosure 12 and there deposit their eggs. Once the mosquitoes reach the bottom 14 of the trap 10, however, the enclosure entry point 24 through which the mosquitoes initially entered the trap 10 becomes hidden from them due to the opaque construction of the conduit 26 and its configuration which prevents light from the entry point 24 from reaching the bottom 14 of the enclosure.

The only apparent exit which the mosquitoes can see from within the enclosure 12 is the translucent portions 32 of the enclosure sidewalls 16. The mosquitoes will therefore attempt to fly out of the trap 10 through these apparent exits. The translucent portions 32, however, are only false exits and do not provide a means by which the mosquito can escape the mosquito trap enclosure. Thus, the mosquitoes have become trapped and are unable to escape from the enclosure.

Once trapped, the mosquitoes subsequently die either from drowning, starvation and/or contact with insecticides included within the trap 10. Mosquito eggs laid within the trap 10, and larva with arise from those eggs, are likewise trapped and die.

The foregoing description of preferred embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A mosquito trap comprising:
a mosquito trap enclosure having at least one sidewall and an interior space within the enclosure;
a combination of water and biomass which is attractive to mosquitoes, located within the enclosure interior space;
at least one entry point formed in the enclosure sidewall allowing mosquitoes to enter the enclosure; and
a conduit having a first opening which is connected to the enclosure entry point and a second opening which is located within the enclosure interior space;
wherein the enclosure interior space is capable of retaining the combination of water and biomass without spillage if the enclosure is overturned.

2. The mosquito trap of claim 1, wherein the conduit substantially prevents rainwater from entering the enclosure interior space.

3. The mosquito trap of claim 1, wherein at least a first portion of the at least one sidewall is translucent and where the conduit is substantially opaque.

4. The mosquito trap of claim 3, wherein the at least one sidewall includes a second portion which is opaque.

5. The mosquito trap of claim 3, wherein the conduit is configured in a shape which substantially prevents exterior light which enters the first opening of the conduit from passing through the conduit and out the second opening of the conduit

6. The mosquito trap of claim 1, wherein the combination of water and biomass further includes an insecticide.

7. The mosquito trap of claim 6, wherein the insecticide is selected from the group consisting of insect growth regulators, microbial larvaecides, organophosphates, synthetic pyrethroids, neonicotinoids, fipronil, surface oils or films and mixtures thereof.

8. The mosquito trap of claim 1, wherein the combination of water and biomass has a volume which is from about 10 to about 50 percent of the total volume of the enclosure interior space.

9. The mosquito trap of claim 1, wherein the combination of water and biomass located within the enclosure interior space has a volume which is from about 0.5 to about 50 liters.
